(19) United States
(12) Patent Application Publication
(10) Pub. No.: US 2006/0015347 A1
(43) Pub. Date: Jan. 19, 2006

(54) Chime MP3 display

(76) Inventors: Scott Blaise Tylicki, Bowling Green, KY (US); William C. Raper, Bowling Green, KY (US); Barry Lee Atkins, Goodlettsville, TN (US); Roger Dennis Cornett, Bowling Green, KY (US)

Correspondence Address: JOHN F. SALAZAR;MIDDLETON & REUTLINGER, 2500 BROWN & WILLIAMSON TOWER, LOUISVILLE, KY, 40202, US

(21) Appl. No.: 10/890,620

(22) Filed: Jul. 14, 2004

(51) Int. Cl. G10L 21/00

(52) U.S. Cl. 704/500

(57) ABSTRACT

A MP3 chime player and display device having a MP3 microcontroller unit being integrated with an in-store display. The in-store display of the present invention has MP3 play selection buttons and associated selection insignia. The microcontroller is in electronic communication with a reprogrammable digital storage device, an electronic port, speakers, volume controls, as well as buttons on the button board or in-store display.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF INVENTION

The present invention relates to an in-store display of merchandise, such as door chimes, having a MP3 player in conjunction with an insignia button board, motion sensor, or other signaling device for sounding chimes, speech, or other sounds.

### DESCRIPTION OF THE PRIOR ART

Current practices for displaying door chimes involves having an in-store display comprised of a sound board and a button board. Each individual chime base or actual product is mounted to the sound board and hardwired to a specific push button or buttons on the button board that activates a specific chime when pressed. An in-store chime display typically has several chimes on display which requires that the sound board holding the chimes to be quite large. Additionally, since these in-store displays have the actual chimes producing the sounds mounted on the sound board, a transformer needs to be mounted on the sound board to supply power to each individual chime since they are low-voltage. If wireless chimes are being displayed, they currently need to be specially modified to convert them to hardwire use so that RF interference is eliminated. Therefore, the wireless chimes also need to be mounted on the soundboard and have power leads attached to the transformer. Since each chime is hardwired to a push button and a transformer the resulting display has a complex and cumbersome wiring arrangement. The result is an expensive and complex display requiring much labor to assemble, modify, and maintain.

These current practices require significant labor and expense to install a chime onto a sound board or to retrofit the sound board with a new chime sound. The resulting display is large and can become unaesthetic. Other problems associated with the current practices is that the soundboards need be displayed in a large area which takes up floor space and limits the locations where the in-store display may be placed. Additionally, the sounds actually come from the chimes mounted on the soundboard and consequently the in-store display must be placed in a location where it will still provide good sound quality for the customer. This further limits the locations where such an in-store display may be placed. These current practices are labor intensive, costly, difficult to retrofit with new chime sounds, undependable, difficult to place within the store, and unaesthetic.

Current practices of displaying merchandise other than door chimes often times require significant labor, expense, and floor space. Therefore, it is contemplated that this invention may be used to display a variety of items within a store where the current practices of displaying such items exhibit some of the aforementioned problems and where some of these problems will be addressed by the present invention.

### BRIEF SUMMARY OF THE INVENTION

One object of the present invention is to create an in-store display of door chimes that requires less labor and cost to install, modify, and maintain.

Another objective of the present invention is to provide a smaller and more versatile in-store display requiring less floor space.

A further object of the present invention is to create a more aesthetic in-store display of door chimes.

These objects and others are accomplished according to the present invention by providing a Chime MP3 Display. The MP3 sound module chime display of the present invention includes a microcontroller housing which houses a microprocessor controlled electronic sound module and a reprogrammable digital storage device such as a multimedia media memory card or flash card. The microcontroller housing has front and rear control access panels. The front control access panel provides volume control switches, an electronic port such as a USB port for loading or deleting sound files, and a ribbon cable receptacle for connecting a button board. The rear access panel provides a power supply receptacle, a removable digital storage device, and a speaker output terminal block.

A ribbon cable extends from the ribbon cable receptacle to a button board. The button board has the insignia or a description of each chime and associated button or buttons. The button board is the only portion of the present invention that needs to be on display to the customer. The inventive design does not need to hold the actual chime bases as in the prior art since the sounds of each chime are stored on the digital memory device or MP3 sound module. Hence, the Chime MP3 Display provides for an aesthetic in-store display of chimes that requires minimal floor space.

The configuration of the MP3 Player provides for easy operation. The customer pushes a button, electronic input means, on the button board display to hear a specific chime sound as indicated by the insignia. The push of the button triggers an input signal to the MP3 microprocessor. The microprocessor's firmware then sends the specific MP3 file or chime tune on the digital storage device that is associated with the pushed button to a digital to audio signal converter. This audio signal is then sent to an amplifier which drives the speakers. Optionally, a speaker unit may be used which houses the signal converter, amplifier, and speaker. The speakers may be mounted anywhere near the button board display to provide quality sound. The firmware is capable of scrolling through several different tunes for a specific electronic input so that all of the tunes for a chime that has multiple tunes may be heard.

The present invention provides for an in-store display of doorbell chimes. The Chime MP3 Display has a display board with buttons and associated insignia or description of the particular chime to sound. The display board may be of almost any size or shape and consequently can be designed to take up very little floor space. The buttons are wired to a microprocessor that is in electronic communication with a digital storage device (i.e. multimedia memory card, flash card, etc.) and speakers. When a button is pressed, the microprocessor sends the associated MP3 file from the digital storage device to the speakers. This provides for a significant cost savings over the prior art by avoiding the wiring, maintenance, and floor space costs incurred by putting the actual doorbell chimes on a board to sound.

### DESCRIPTION OF DRAWINGS

FIG. 1 is a schematic diagram showing the elements of the present invention and their relationship to one another;

FIG. 2 is a perspective view of the MP3 Player of the present invention showing details of each element;

FIG. 3 is a perspective view of the rear of the microcontroller housing shown in FIG. 2; and

FIG. 4 is a perspective view of the front of the microcontroller housing shown in FIG. 2.

### DETAILED DESCRIPTION OF THE PREFERRED EMBODIMENTS

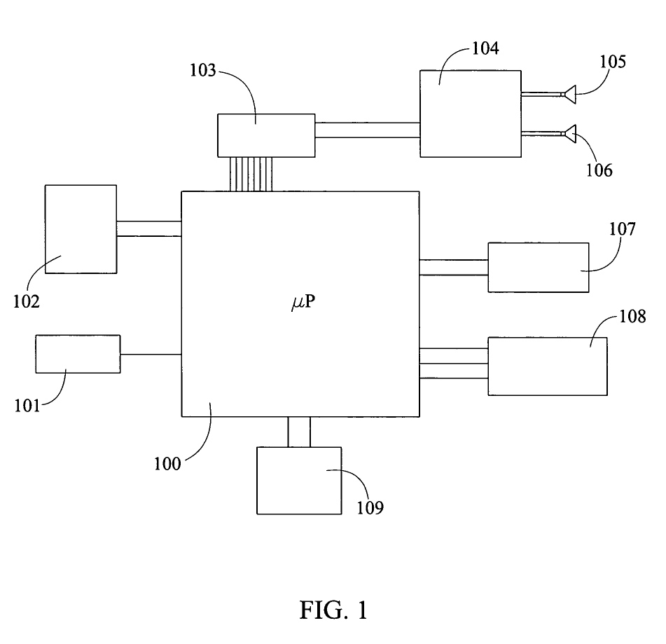

The Chime Display of the present invention may best be described with reference to the figures. FIG. 1 provides a schematic diagram showing the elements of the present invention and their relationship to each other. Firmware resides in the microcontroller unit or microprocessor (μP) 100 and is in electronic communication with each element of the present invention. A power supply 109 provides power to the microcontroller and is typically an off-the-shelf UL listed wall transformer that converts 120 V AC to 12V DC. Volume controls 101 provide input to the microcontroller 100 based on the users setting of the volume controls 101. The button board 102 displays the buttons and associated insignia or chime descriptions and provides the customer with a convenient customer input device for selecting a chime to sound. When one of a plurality of buttons on the button board 102 is pressed by a customer a signal is sent to the microcontroller 100 and the firmware accesses the digital storage device or media 108 and sends the associated digital audio file or sound file such as an MP3 file to the digital to audio converter 103. The audio signal is sent to the amplifier 104 which causes the speakers 105 and 106 to produce the sound associated with the selected unique chime. The digital memory device or digital storage media 108, may be a multi-media memory card, flash card or other digital storage device. The digital storage device 108 may be a type that can be a type that can be removed, reprogrammed or replaced. Additionally, the digital storage device 108 may be reprogrammed in place via an electronic port 107 such as a USB, parallel, or serial port. Hence, new digital or MP3 files may be loaded onto digital storage media 108 via the electronic port 107. In other words, new chimes may be easily stored by the Chime Display of the present invention.

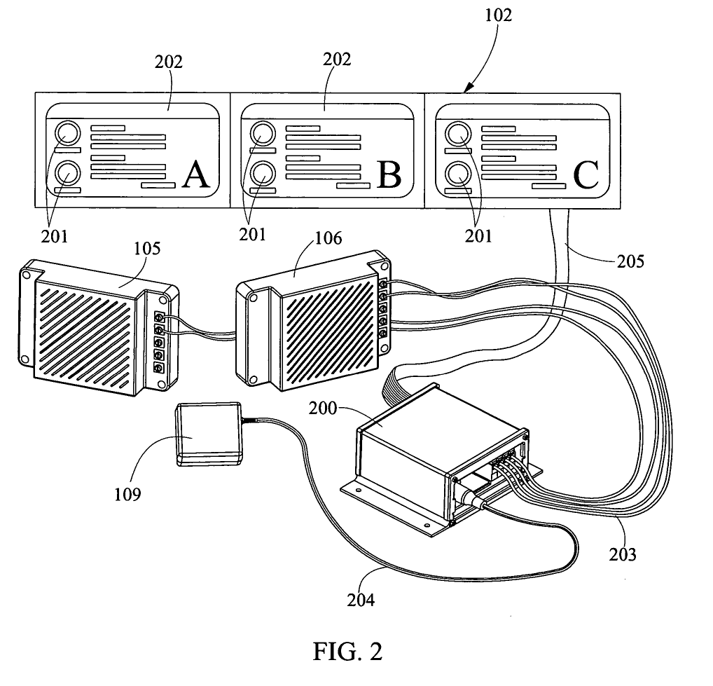

FIG. 2 provides a perspective view of the present invention showing details of each element of the present invention. Button board 102 has insignia 202 or a description of each chime that is on display. In close proximity to each insignia 202 is an electronic input means or customer input device such as a play selection button 201 or a plurality of play selection buttons 201 that are associated with the proximal insignia 202 or description. A ribbon cable 205 electronically connects the buttons 201 to the microcontroller 100 that is mounted in microcontroller housing 200. FIG. 2 also shows the speaker housings 105 and 106 being electronically connected to the microcontroller 100 within microcontroller housing 200 via speaker wires 203. Additionally, power supply 109 is shown to be in electronic communication with the microcontroller 100 via power supply cable 204.

As can be readily seen, the chime display of the present invention allows for a user to hear the doorbell sounds associated with a plurality of chimes associated with buttons 201 and insignias 202 without the necessity of a completely wired replica doorbell chime display utilizing the actual products. The digital storage media 108 of the present invention stores a plurality of sound files associated with each button 201 and insignia 202 so that a customer may hear the associated doorbell chime.

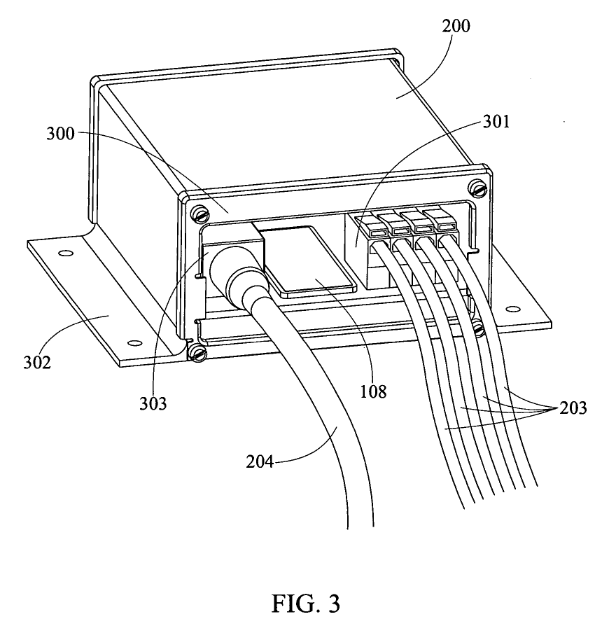

FIG. 3 provides a perspective view of the rear control access panel 300 of the microcontroller 100 within microcontroller housing 200. The rear control access panel 300 has a power supply receptacle 303 that receives power supply cable 204. On the opposite side of the rear control access panel 300 is a speaker output terminal block 301 that provides a digital signal to the digital to audio converter 103 via speaker wires 203. Alternatively, digital to audio converter 103 may be contained within housing 200. In this alternate embodiment, speaker output terminal block 301 provides an audio signal to speaker wires 203. Between the speaker output terminal block 301 and power supply receptacle 304 is digital memory device 108 in electronic communication with microcontroller 100. Digital storage media 108 is shown to be installed in a holder recessed in the rear control access panel 300. Digital storage media 108 may be removed from this holder and replaced if so desired or reprogrammed. FIG. 3 also depicts mounting flanges 302 extending from microcontroller housing 200.

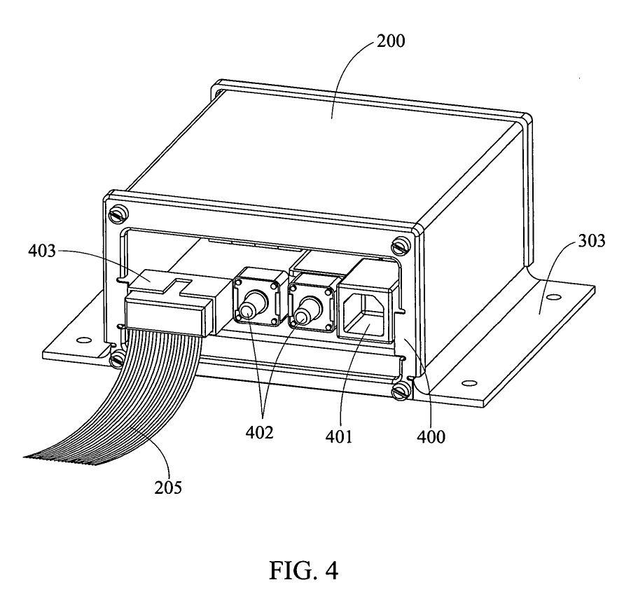

FIG. 4 is a front perspective view of the microcontroller housing. Front control access panel 400 has ribbon cable receptacle 403, volume control switches 402, and an electronic port 401, all of which are in electronic communication with microcontroller 100 within housing 200. Ribbon cable receptacle 403 receives ribbon cable 205 which connects to the play selection buttons 201 on button board 102. The volume control switches 402 are connected to microcontroller 100 in microcontroller housing 200 and provide the user the ability to adjust the loudness of the chimes being sounded in speakers 105 and 106. Electronic port 401 provides electronic access to microcontroller 100 and hence all of the elements in electronic communication with microcontroller 100. Electronic port 401 may be used to access the chime files or MP3s on the digital storage media 108 so that the digital storage device 108 may be reprogrammed without having to be removed. Typically this is done by connecting a computer to the microcontroller 100 via electronic port 401. Electronic port 401 may be a USB, parallel, serial, or other port that provides electronic communication with microprocessor 100. The firmware in conjunction with the computer software allows the user to delete, add, or rearrange chimes on digital memory device 108 via electronic port 401.

These figures provide for a single embodiment of the present invention. As one skilled in the art can appreciate, there are many alternative embodiments of the present invention. For instance, front panel 400 and rear panel 300 could be combined by having a single top panel which would provide for the microcontroller 100 access. The housing 200 could provide for a larger surface area on the front panel 400 or rear panel 300 providing enough area to place all of the controls or microcomputer 100 access ports 401 on a single panel thus eliminating one of the access panels. Alternatively, electronic port 401 could be a USB, serial or parallel port or even be eliminated. This may then require digital storage media 108 to be removed to be reprogrammed, yet the present invention would still provide a useful and novel function. Therefore, the figures serve to describe only a single embodiment of the present invention and do not serve to limit the many alternative embodiments claimed herein. In fact the present invention may be used to display a variety of merchandise within a store and still be within the scope of the presently claimed invention. For example, a heater system could be displayed by the present invention where the electronic input device 201 may have buttons 201 on a button board 102 and/or a motion sensor associated with specific electronic files that describe the heater with a sensory output device such as an audio/visual output device that may deliver voice (i.e. description or instructions), graphics, video, or other audio/visuals.

We claim:

1. A reprogrammable merchandise display comprising a microcontroller unit and a button board with a plurality of buttons, wherein each of said buttons are electronically connected to said microcontroller unit and associated with a unique sound file.

2. The merchandise display of claim 1 wherein said microcontroller unit is in electronic communication with a digital memory device.

3. The merchandise display of claim 1 wherein said microcontroller unit is in electronic communication with an electronic port.

4. The merchandise display of claim 1 wherein said microcontroller unit is in electronic communication with at least one speaker.

5. The merchandise display of claim 1 wherein said microcontroller unit is in electronic communication with a power supply.

6. The merchandise display of claim 1 wherein said microcontroller unit is enclosed within a housing.

7. The merchandise display of claim 6 wherein said housing has at least one control access panel.

8. The merchandise display of claim 7 wherein said at least one control access panel has a receptacle for an electric cable leading to said button board.

9. The merchandise display of claim 1 wherein said merchandise display has at least one volume control.

10. The merchandise display of claim 7 wherein said least one control access panel has a speaker output terminal block.

11. A method of displaying merchandise comprising:
displaying a button board having a plurality of buttons and associated insignia;
associating a unique sound file with each of said plurality of buttons;
storing each of said unique sound files on a digital storage media; and
playing a selected one of said plurality of sound files on said digital storage media when an associated button on said button board is depressed.

12. The method of displaying merchandise of claim 11 having the additional step of converting said sound file to an audio signal with a digital to audio converter.

13. The method of displaying merchandise of claim 12 having the additional step of amplifying said audio signal.

14. The method of displaying merchandise of claim 11 wherein said digital storage media is removable and reprogrammable.

15. The method of displaying merchandise of claim 11 further comprising an electronic port for reprogramming said unique sound files stored on said digital storage media.

16. A merchandise display device comprising a button board display having at least one button and associated chime description and a microcontroller unit associating each of said at least one button with a unique chime.

17. The merchandise display device of claim 16 further comprising at least one digital to audio signal converter, at least one amplifier, and at least one speaker in linear electronic communication with said microcontroller unit.

18. The merchandise display device of claim 16 wherein said device further comprises a digital memory device storing said unique chimes.

19. The merchandise display device of claim 18 wherein said digital memory device is reprogrammable and removable.

20. The chime player and display device of claim 18 wherein said device further comprises an electronic port providing digital access to said microcontroller unit and said digital memory device.

21. A merchandise display device comprising:
a microcontroller having an electronic input means;
at least one electronic file associated with said electronic input means; and
at least one sensory output device in electronic communication with said microcontroller.

22. The merchandise display device of claim 21 wherein said electronic input means is at least one button.

23. The merchandise display device of claim 21 wherein said electronic input means is a motion sensor.

24. The merchandise display device of claim 21 wherein said at least one sensory output device has at least one speaker.

25. The merchandise display device of claim 21 wherein said at least one sensory output device is a visual display.

26. A heater system display device comprising:
a customer input device;
at least one electronic file associated with said customer input device; and
at least one audio/visual output device.

27. The heater system display device of claim 26 wherein said customer input device is a motion sensor.

28. The heater system display device of claim 26 wherein said customer input device is at least one button, where said at least one button is associated with specific insignia.

29. The heater system display device of claim 26 wherein said audio/visual device has at least one speaker.

30. The heater system display device of claim 26 wherein said audio/visual device has a visual output device.
